(19) United States
(12) Patent Application Publication
(10) Pub. No.: US 2007/0221080 A1
(43) Pub. Date: Sep. 27, 2007

(54) Re-imageable and Erasable Printing Form of a Printing Press

(75) Inventors: Ralph Klarmann, Augsburg (DE); Hartmut Fuhrmann, Bobingen (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/689,398

(22) Filed: Mar. 21, 2007

(30) Foreign Application Priority Data
Mar. 22, 2006 (DE) 10 2006 013 637.3

(51) Int. Cl. B41N 1/00

(52) U.S. Cl. 101/395

(57) ABSTRACT

A printing form, specifically a re-imageable and erasable printing form, is disclosed. The printing form has an inner support layer providing mechanical stabilization, an outer dielectric functional layer serving to transfer printing ink, and conductive surface elements disposed between the support layer and the dielectric functional layer, specifically configured as electrodes, to which electrical voltages can be applied to change the surface-energy of the dielectric functional layer by area such that, depending on the voltages applied to the conductive surface elements, first ink-bearing areas and second non ink-bearing areas can be formed on the dielectric functional layer.

This application claims the priority of German Patent Document No. 10 2006 013 637.3, filed Mar. 22, 2006, the disclosure of which is expressly incorporated by reference herein.

### BACKGROUND AND SUMMARY OF THE INVENTION

The invention relates to a printing form. The invention further relates to a printing couple for a printing press.

In printing technology a principle distinction is made between printing form-based printing processes and printing form-free printing processes, where the printing form-free printing processes are also designated as non-impact printing processes. Among the printing form-based printing processes are screen printing, letterpress printing, flat printing and rotogravure printing, where offset printing in particular is included under flat printing.

In the case of the printing form-based printing processes, a distinction can be made between printing processes which operate either with one-time writable printing forms or with re-writable and erasable printing forms. The present invention relates to the area of the printing form-based printing processes, specifically flat printing processes, which operate with erasable and re-writable printing forms.

Different approaches are known from the prior art to realize erasable and re-writable printing forms. The prior art in accordance with European Patent Document No. EP 1 155 871 B1 discloses a procedure for treating an erasable and re-writable printing form in which an ink-friendly material is applied to a dampening solution-friendly surface of a printing form cylinder by means of an ink jet, where the applied material is dried or cured and removed using an imaging device, for example, a laser.

EP 1 118 470 B1 relates to a printing process using a re-writable printing form in which a coating consisting of a hydrophobic, thermoplastic material and a hydrophilic binder is applied on a hydrophilic substrate. This applied coating is irradiated image by image, where the thermoplastic material melts together with the hydrophilic surface in the irradiated areas and forms image areas. The non-irradiated areas are removed in the printing process wherein the hydrophilic substrate is exposed at these points.

In the case of the above procedures known from the prior art, an imaging material has to be applied to the printing form to image them, which has to be removed from the same when erasing the printing forms after printing. This involves great expense for process equipment.

A re-writable and erasable printing plate for flat printing is known from EP 1 016 519 B1, which is configured as a lithographic printing plate. The lithographic printing plate disclosed there has a photo conductor, where the entire surface of the photo conductor is charged by a charging device, and where the photo conductor is subsequently exposed with the information to be printed. In the exposed areas of the photo conductor, the charges run off. In the unexposed areas, the charges remain on the surface. The photo conductor then bears a charge image corresponding to the print information and is brought into contact with printing ink and dampening solution. Wherever the charges have remained on the photo conductor, the dampening solution moistens the surface of the photo conductor and the printing ink cannot accumulate. In the charge-free areas of the photo conductor, on the other hand, the printing ink for the image to be printed accumulates. A charging device which generates a homogenously distributed charge and an imaging device which generates the charge image are required for the operation of this printing plate. This also involves great expense for process equipment.

With this as a point of departure, the problem underlying the present invention is to create a novel printing form and a novel printing couple for a printing press. The printing form in accordance with the invention has an inner support layer for mechanical stabilization, an outer dielectric functional layer for transferring printing ink and conductive surface elements located between the support layer and the functional layer, configured specifically as electrodes, where electrical voltages can be applied to the surface elements to change the surface energy, or surface tension, of the functional layer by area in such a way that first ink-bearing areas and second non ink-bearing areas can be formed on the dielectric functional layer, depending on the voltages applied to the conductive surface elements.

The present invention provides a printing form in which the imaging is carried out by applying different electrical voltages to the conductive surface elements of the printing form. The imaging takes place without any transfer of material, simply by applying the different electrical voltages. Consequently, no material needs to be removed from the printing forms for erasure. Furthermore, no special charging devices or exposing units are required so that ultimately the imaging and image erasure of the printing form in accordance with the invention can be carried out with very low process technical costs.

The dielectric functional layer preferably has a dielectric constant greater than or equal to 2 and a thickness less than or equal to 100 μm, where the layer is formed specifically of a plastic or a ceramic material or a carbon-based material or is coated with such a material.

Preferred refinements of the invention can be derived from the description hereinafter. Embodiments of the invention, without being restricted thereto, are explained in more detail with reference to the drawings.

### BRIEF DESCRIPTION OF THE DRAWINGS

FIG. 1 shows a schematic cross-section through a printing form in accordance with the invention;

FIG. 2 shows the printing form in accordance with the invention from FIG. 1 together with a counter electrode;

FIG. 3 show a plan view of conductive surface elements of the printing forms in accordance with the invention;

FIG. 4 show a further plan view of conductive surface elements of the printing form in accordance with the invention; and

FIG. 5 shows a plan view of one of the conductive surface elements of the printing form in accordance with the invention.

### DETAILED DESCRIPTION OF THE DRAWINGS

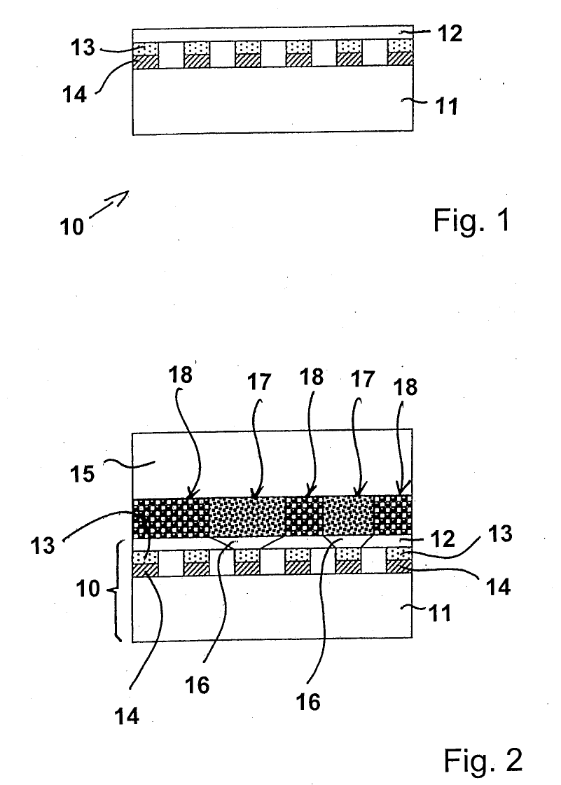

FIG. 1 show a schematized cross-section through a printing form in accordance with the invention for flat printing, specifically for offset printing, wherein the printing form is writeable, or can be imaged, and erasable, or can have the images removed, and is thus usable multiple times.

The printing form in accordance with FIG. 1 has an inner substrate, or an inner support layer 11, and an outer functional layer 12 The inner support layer 11 serves to mechanically stabilize the printing form 10 in accordance with the invention. The outer functional layer 12, on the other hand, serves to transfer printing ink and thus serves the printing process.

The functional layer 12 is made from a dielectric material and consequently designed as a dielectric functional layer.

Several conductive surface elements 13 are located between the inner support layer 11 and the outer, dielectric functional layer 12 which are preferably designed as electrodes. Electrical voltages can be applied to the conductive surface elements 13 through which, adapted to an image to be printed, the surface energy or surface voltage of the dielectric functional layer 12 can be modified by area or by section such that the dielectric functional layer 12 has first ink-bearing areas and second non ink-bearing areas, as a function of the voltages applied to the conductive surface elements 13.

In accordance with FIG. 1, a switching element 14 is assigned to each conductive surface element 13 through which an electrical current can be applied to the specific surface element 13 and/or through which the amount, or the magnitude, of the specific electric voltage applied can be adjusted.

Through the electrical voltage applied to a conductive surface element 13, an area of the dielectric functional layer 12 adjacent the surface element 13 can be changed with respect to its surface energy in order to form the first ink-bearing areas and second non ink-bearing areas of the dielectric functional layer 12. According to a first alternative, it is possible that when no voltage is applied to a surface element 13, or the voltage applied to the surface element is less than a threshold value, the area adjacent the surface element 13 of the dielectric functional layer 12 is ink-bearing, whereas when a voltage is applied to the surface element 13, or the voltage applied to the surface element is higher than a threshold value, the area of the dielectric functional layer adjacent the surface element 13 is non ink-bearing.

According to a second alternative, it is also possible that when no voltage is applied to the surface element 13, or the voltage applied to the surface element is less than a threshold value, the area of the dielectric functional layer 12 adjacent the surface element is non ink-bearing, whereas when a voltage is applied to the surface element 13, or the electrical voltage applied to the surface element is higher than a threshold value, the area of the dielectric functional layer 12 adjacent the surface element 13 is ink-bearing. Which of the above alternatives is employed depends, among other factors, on the printing inks used.

Preferably a material is selected for the dielectric functional layer 12 which has low polarity so that the layer is ink-bearing by applying electrical voltages to the surface elements 13 without any change in the surface energy. By applying an electrical voltage to surface elements 13, areas adjacent to the surface elements 13 can be changed with respect to the surface voltage, or surface energy, such that the polar proportion of the surface voltage increases so that the areas are not ink-bearing.

A plastic or a ceramic material can be used as the material for the dielectric functional layer 12. Polyethylenes (PE), polypropylenes (PP) or polytetrafluoroethylenes (PTFE) are particularly suitable as the plastic.

Alternatively, the dielectric functional layer 12 can also be made from a carbon-based material with high wear-resistance, for example from polycrystalline or amorphous diamond-like carbon (DLC). It is similarly also possible to coat the dielectric functional layer on the outside with one such material.

The material for the dielectric functional layer is further selected such that the dielectric functional layer 12 has a high relative dielectric constant which is greater than or equal to 2. Specifically, the dielectric constant of the functional layer 12 is greater than or equal to 10, preferably greater than or equal to 100.

Further, the film thickness of the dielectric functional layer 12 is preferably thin so that when even low voltages are applied to the surface elements 13, the surface energy, or surface voltage, of the areas adjacent the dielectric functional layer 12, and thus the wetting properties of the areas, can be changed. The dielectric functional layer 12 has a thickness less than or equal to 100 μm, specifically a thickness less than or equal to 50 μm. The thickness of the dielectric functional layer 12 is preferably less than or equal to 10 μm.

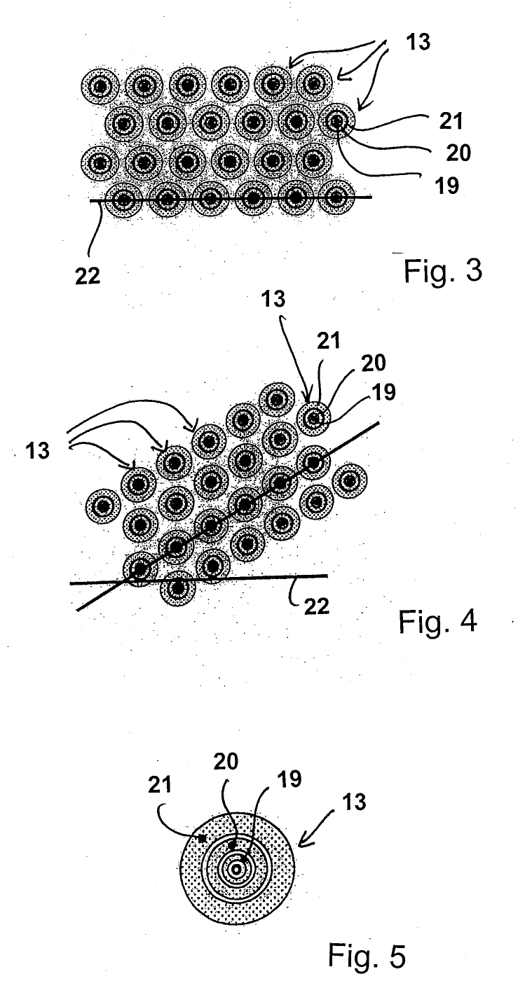

The conductive surface elements 13 of the printing form 10 in accordance with the invention, which are preferably configured as electrodes, are electrically insulated on the one part from the support layer 11 and for the other part from each other. An individual electrical voltage can be applied, in conjunction with the switching elements 14, to each of the surface elements 13 through electric wires (not shown). In accordance with FIGS. 3 and 4, the conductive surface elements 13 form a two-dimensional array, wherein the surface elements 13 in the embodiment from FIGS. 3 and 4 have a circular surface or border. Other shapes, for example oval shapes or triangular or stellate shapes are possible for the conductive surface elements 13.

As has been mentioned several times, the surface property of the dielectric functional layer 12 can be changed by the specific application of electrical voltages to the conductive surface elements 13 such that ink-bearing areas and non ink-bearing areas on the functional layer 12 can be formed selectively.

A counter electrode 15 interacts collaboratively with the surface elements 13 which are configured as electrodes, wherein the counter electrode 15 is formed by a roller rolling on the printing form 10 when printing, or by a cylinder rolling on the printing form 10 when printing. In the case of the counter electrode 15, it can be a form roller for an inking couple or a dampening system, or a transfer cylinder for a printing couple.

By applying defined electrical voltages to the surface elements 13 of the printing form 10 configured as electrodes, an electrical field forms between the surface elements 13 to which a voltage is applied and the counter electrode 15, where the electrical fields ultimately adjust or change the surface energy, or surface voltage, of the dielectric functional layer 12 in order to form the ink-bearing areas and non ink-bearing areas in this manner.

In the representation of FIG. 2, an electrical current has been applied to two surface elements 13, specifically to the third surface element as viewed from the left and to the fifth surface element as viewed from the left, wherein the surface energy, or surface voltage, is changed in the areas 16 of the dielectric functional layer 12 adjacent these surface elements compared with the other areas of the functional layer 12.

Thus, in the embodiment from FIG. 2, the areas 16 of the dielectric functional layer 12 are non ink-bearing so that dampening solution 17 collects on these areas. In the areas of the functional layer 12 which are adjacent the surface elements 13 and to which no electrical voltage has been applied, the functional layer, on the other hand, is ink-bearing so that printing ink 18 collects in these areas.

In the case of the printing form 10 in accordance with the invention, a two-dimensional array of conductive surface elements 13 is consequently located under a relatively thin dielectric functional layer 12, where the surface elements 13 are preferably designed as energizable electrodes to each of which a switching element 14 is allocated. An individual electrical current can be applied to each of the surface elements 13 so that an individual electrical field forms between the specific surface element 13 and the counter electrode 15. The surface property, specifically surface energy or surface voltage, and thus the wetting capability of the areas of the dielectric functional layer 12 located opposite the surface elements 13 can be manipulated to form the ink-bearing areas and non ink-bearing areas of the printing form in the sense of imaging the form.

It is possible to design the support layer 11, the dielectric functional layer 12 and the surface elements 13 located between the support layer 11 and the functional layer 12 and switching elements 14 in the sense of a printing plate, or of a printing sleeve, as an integral component which is then positioned on a form cylinder of a printing couple. Different from this, it is also possible to design the dielectric functional layer 12 as a separate component so that the layer can be separated from the remaining subassemblies of the printing form, specifically from the support layer 11, the surface elements 13 and switching elements 14 for cleaning or replacement when it becomes necessary. It is also possible to integrate the support layer 11, the surface elements 13 and switching elements 14 into the surface of a form cylinder.

When printing using the printing form in accordance with the invention, printing ink as well as dampening solution is applied to the printing form with the aid of form rollers so that a printing ink-dampening solution emulsion is formed on the surface of the printing form, specifically on the dielectric functional layer 12 of the form.

By applying individual electrical currents to the surface elements 13 of the printing form 10 configured as electrodes, an individual electrical field forms in each instance between the surface elements 13 and the form rollers acting as a counter electrode 15 to establish the areas of the printing form in which printing ink, and in which areas dampening solution, collects. Each time a form roller and the transfer cylinder rolls over the printing form 10, the above electrical fields form in the corresponding transfer gaps between the printing form 10 and the form rollers, or the transfer cylinder, so that the specified ink-bearing areas and the non ink-bearing areas of the dielectric functional layer 12 are formed in each transfer gap.

Since the printing ink used in flat printing is usually relatively viscous, the distribution of the printing ink into the ink-bearing areas of the printing plate does not happen spontaneously, but requires the assistance of the pressing forces in the transfer gap between the printing plate and the form rollers, or the transfer cylinder, at the same moments when the electrical field exists which forms the ink-bearing and the non ink-bearing areas. After changing the electrical activation of the surface elements 13 configured as electrodes, the new print image forms within a relatively short wetting conversion phase.

In the representation shown in FIG. 2, the area 16 of the dielectric functional layer 12 formed by application of an electrical current, which is formed adjacent the third surface element 13 as viewed from the left, is greater than the area 16 which is formed adjacent the fifth surface element 13 as viewed from the left. The size of the non ink-bearing, or ink-bearing, areas of the dielectric functional area 12 can then be determined thereby in the sense of amplitude-modulated screening, in order to be able to reproduce half-tones for greater differentiation of an image to be printed.

The size of the ink-bearing and non ink-bearing areas of the dielectric functional layer 12 formed by applying an electrical current to the surface elements 13 is consequently dependent on the magnitude of the voltage applied to the elements in the embodiment in FIG. 2.

If the differentiation of a print image achievable by this means should not be adequate, surface elements 13 can be used which, in accordance with FIG. 5, have several areas 19, 20, or 21 which can be activated separately, or independently of each other and can have an electrical current applied. An individual current can be applied to each of these areas, 19, 20, 21 as well in order to establish in the sense of amplitude-modulated screening the size of the ink-bearing and the non ink-bearing areas of the dielectric functional layer 12. In the embodiment from FIG. 5, the areas 19, 20, 21 are concentrically nested rings. However, as elaborated previously, other shapes for surface elements 13 can be realized, for example, triangular, square, oval, stellate or chain-shaped surface elements.

It should be pointed out that the surface elements 13 for reproducing half-tones can also be used in the sense of a dither matrix in conjunction with a corresponding activation of same by imposing an electrical voltage on the elements. When the surface elements 13 are used in a dither matrix, the number of surface elements is guided by distinguishable coverage per pixel. When the surface elements are combined into a dither matrix, the size of the surface of a pixel belonging to a dither matrix is controlled through the electrical voltage at the individual surface elements.

As already mentioned, the surface elements 13 configured as electrodes are disposed on the support layer 11 of the printing form 10 in the form of a two-dimensional array. The distances between the center points of adjacent surface elements 13 is fixed and cannot be changed. Since the danger of creating moire-effects exists with multi-color, autotypical simultaneous printing, the arrays of the surface elements 13 can be angled differently, as can be seen from a comparison of FIGS. 3 and 4.

Thus, in FIG. 3, rows of surface elements 13 run parallel to a longitudinal direction of the printing form defined by the straight line 22. In FIG. 4, on the other hand, the rows of the surface elements 13 include a relatively acute angle, compared with the straight line 22. If print plates with suitably different angulation for the two-dimensional arrays from the surface elements 13 are used on the print couples involved in autotypical simultaneous printing, the moiré-effects which compromise print quality can be prevented.

It should be pointed out that the distance between the center points of adjacent surface elements 13 is preferably less than or equal to 1 mm, in particular less than or equal to 200 μm.

The printing form in accordance with the invention 10 is used preferably in flat printing, specifically in offset printing, wherein form rollers of an inking couple, form rollers of a dampening system and the transfer cylinder form counter electrodes for the surface elements 13 of the printing form 10.

A printing press, on whose printing couples the printing form in accordance with the invention is to be used, must have a control device in order to activate the individual surface elements 13 of the printing form 10 using appropriate electrical voltages. When a printing press uses the printing form 10 in accordance with the invention, a printing form does not have to be changed in order to change a print image. To alter a print image, or to delete and re-image the print form, only the activation of the surface elements has to be modified using electrical voltages.

To do this, no imaging material has to be applied to the printing form. Further, no cleaning measures or other mechanical or chemical intervention on the plate cylinder, or the printing form, is necessary.

Furthermore, during the printing process, the hue can be regulated by appropriate activation of the surface elements of the printing form within a few copies to correct print deviations. As long as such corrections are kept within certain boundaries and changes in the ink flow can be absorbed by the storage capability of the inking couple, relatively fast control of coloring in the print product can be achieved.

In the embodiment shown, the switching elements 14 configured as electrodes, which serve to activate the surface elements 13, are integrated into the printing form 10. Distinct from this, it is also possible that the switching elements 14 for activating the surface elements 13 are located outside the printing form.

List of Reference Numerals:
10 Printing form
11 Support layer
12 Functional layer
13 Surface element
14 Switching element
15 Counter electrode
16 Area
17 Dampening solution
18 Printing ink
19 Surface element area
20 Surface element area
21 Surface element area
22 Reference line

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing form, specifically a re-imageable and erasable printing form, having an inner support layer providing mechanical stabilization, an outer dielectric functional layer serving to transfer a printing ink, and conductive surface elements disposed between the support layer and the dielectric functional layer, wherein the surface elements are configured as electrodes to which electrical voltages are applied to change a surface energy of an area of the dielectric functional layer such that, depending on a voltage applied to the conductive surface elements, first ink-bearing areas and second non ink-bearing areas are formed on the dielectric functional layer.

2. The printing form according to claim 1, wherein depending on the voltages applied to the conductive surface elements, between the dielectric functional layer and a counter electrode, electrical fields are formed, as a function of which the first ink-bearing areas and the second non ink-bearing areas form on the dielectric functional layer.

3. The printing form according to claim 1, wherein at least one switching element is allocated to each conductive surface element, and wherein an amount, or a magnitude, of the electrical voltage applied to a particular surface element is adjustable through the switching element.

4. The printing form according to claim 1, wherein by means of the electrical voltage applied to the conductive surface elements an area of the dielectric functional layer adjacent a respective surface element is changeable with respect to its surface energy, wherein when no voltage is applied to the surface element, or the voltage applied to the surface element is less than a threshold value, an adjacent area of the dielectric functional layer is ink-bearing, and wherein when a voltage is applied to the surface element, or the voltage applied to the surface element is higher than a threshold value, the adjacent area of the dielectric functional layer is non ink-bearing.

5. The printing form according to claim 1, wherein by means of the electrical voltage applied to the conductive surface elements an area of the dielectric functional layer adjacent a respective surface element is changeable with respect to its surface energy, wherein when no voltage is applied to the surface element, or the voltage applied to the surface element is less than a threshold value, an adjacent area of the dielectric functional layer is non ink-bearing, and wherein when a voltage is applied to the surface element, or the voltage applied to the element is higher than a threshold value, the adjacent area of the dielectric functional layer is ink-bearing.

6. The printing form according to claim 1, wherein the dielectric functional layer has a dielectric constant greater than or equal to 2.

7. The printing form according to claim 1, wherein the dielectric functional layer has a thickness less than or equal to 100 μm.

8. The printing form according to claim 1, wherein the dielectric functional layer is made from, or coated with, a plastic material, or a ceramic material, or a carbon-based material.

9. The printing form according to claim 1, wherein the conductive surface elements are electrically insulated on a first part from the support layer and on a second part from each other, and wherein the conductive surface elements form a two-dimensional array.

10. The printing form according to claim 1, wherein a distance between a center point of adjacent conductive surface elements is less than or equal to 1 mm.

11. The printing form according to claim 1, wherein the conductive surface elements are combined into a dither matrix.

12. The printing form according to claim 1, wherein each of the conductive surface elements is exposable to an individual electrical voltage such that, depending on an amount, or a magnitude, of the voltage applied, a size of the ink-bearing and non ink-bearing areas of the dielectric functional layer is established.

13. The printing form according to claim 1, wherein each of the conductive surface elements has several areas which are activateable separately, or independently, of each other and are exposable to an electrical voltage such that depending on which of these several areas are exposed to the electrical voltage, a size of the non ink-bearing and ink-bearing areas of the dielectric functional layer is established.

14. The printing form according to claim 1, wherein the dielectric functional layer which is in contact with the printing ink and a dampening solution and which serves to transfer the printing ink is configured such that it is separable from the support layer and the surface elements.

15. A printing couple for a printing press, having a form cylinder on which at least one printing form is disposed, having an inking couple which applies a printing ink to the printing form by means of at least one form roller, having a dampening system which applies a dampening solution to the printing form by means of at least one form roller, and having a transfer cylinder co-acting with the form cylinder which transfers the printing ink onto a substrate, wherein the printing form disposed on the form cylinder is configured in accordance with claim 1, where the form rollers and the transfer cylinder form counter electrodes to the conductive surface elements of the printing form such that, depending on the voltages applied at the conductive surface elements, electrical fields form between the counter electrode configured as the form rollers or transfer cylinder and the conductive surface elements, which, depending on a rotation of the form cylinder in an area of a transfer gap, are located between the counter electrode and the form cylinder, wherein the dielectric functional layer of the printing form has first ink-bearing and second non ink-bearing areas, depending on these electrical fields.

16. A printing press, comprising:
a printing form, having an inner support layer, an outer dielectric functional layer, and a conductive surface element disposed between the inner support layer and the outer dielectric functional layer;
wherein a voltage is applied to the conductive surface element such that an area of the outer dielectric functional layer associated with the conductive surface element is configured as either an ink-bearing area or a non ink-bearing area based on the voltage applied to the conductive surface element.

17. The printing press according to claim 16, further comprising a switching element coupled to the conductive surface element.

18. The printing press according to claim 16, further comprising a counter electrode, wherein the counter electrode is formed on a form roller or a transfer cylinder, and wherein an electrical field is formed at the area of the outer dielectric functional layer in a gap between the outer dielectric functional layer and the form roller or transfer cylinder each time the form roller or transfer cylinder rolls over the printing form.

19. A method of imaging a printing form, wherein the printing form has an inner support layer, an outer dielectric functional layer, and a conductive surface element disposed between the inner support layer and the outer dielectric functional layer, comprising the steps of:
applying a voltage to the conductive surface element such that an area of the outer dielectric functional layer associated with the conductive surface element is configured as either an ink-bearing area or a non ink-bearing area based on the voltage applied to the conductive surface element.

20. The method according to claim 19, further comprising the step of forming an electrical field at the area of the outer dielectric functional layer in a gap between the outer dielectric functional layer and a counter electrode, wherein the counter electrode is formed on a form roller or a transfer cylinder, each time the form roller or transfer cylinder rolls over the printing form.
